(19) United States
(12) Patent Application Publication
(10) Pub. No.: US 2002/0068887 A1
(43) Pub. Date: Jun. 6, 2002

(54) Massage machine and electronic device having controller

(76) Inventors: Makoto Kikumoto, Osaka (JP); Kunihiko Hori, Osaka (JP); Yoshihisa Fujiwara, Uji-shi (JP); Kazuya Hiyamizu, Osaka (JP); Hirokazu Genno, Osaka (JP); Masashi Yasuda, Osaka (JP); Toshiki Koma, Himeji-shi (JP); Masao Kume, Osaka (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/995,801

(22) Filed: Nov. 29, 2001

(30) Foreign Application Priority Data
Nov. 30, 2000 (JP) 2000 - 366307
Nov. 30, 2000 (JP) 2000 - 366308
Nov. 30, 2000 (JP) 2000 - 366309

(51) Int. Cl. A61H 1/00

(52) U.S. Cl. 601/49; 601/57

(57) ABSTRACT

The present invention provides a massage machine comprising a living body information sensor 5 for detecting the living body information of the autonomic nervous system of the person to be massaged, and a control circuit 6 for controlling massage based on the living body information detected by the sensor 5. The control circuit 6 estimates the psychological state of the person based on variations in the living body information detected by the sensor 5, and adjusts massage movement in accordance with the estimated psychological state. In adjusting the massage movement, one of a relaxation mode and a refreshment mode can be selected, and the massage movement is so adjusted as to lower the activity of the autonomic nervous system in the relaxation mode, or is so adjusted as to increase the activity of the autonomic nervous system in the refreshment mode.

### FIELD OF THE INVENTION

The present invention relates to massage machines adapted to give one kind or some kinds of massages to the user, and more particularly to massage machines which are adapted to give a massage as automatically adjusted in accordance with the preference or condition of the person to be massaged and also to electronic devices equipped with a controller for feeding control signal signals to the device body to control the operation of the device body.

### BACKGROUND OF THE INVENTION

Massage machines are already in wide use which are adapted to automatically give massage to the user. With reference to FIG. 1, such a massage machine comprises a chair body 10 including legs 11, seat 12, backrest 13 and a pair of opposite armrests 14, 14, and a massage mechanism 2 having a plurality of therapeutic members 21 and incorporated into the body 10. The therapeutic members 21 are reciprocally moved up and down while being vibrated, whereby the human body is massaged.

The massage machines of the type mentioned include one which is adapted to detect a stiff body part before giving a massage so as to massage the most appropriate part concentrically [JP-A No. 9-75413(1997)]. Although this machine is capable of giving a massage concentrically to the stiff part of the body detected, the machine is unable to detect the psychological state such as “comfort” or “pain” and therefore has the problem of failing to give an effective massage for realizing an enhanced degree of relief or a more refreshed feeling. Accordingly, a massage machine is proposed which is adapted to detect relaxation indicating factors of the person to be massaged, such pulse, body temperature and skin electrical resistance, for controlling a massage mechanism in accordance with the degree of relaxation of the person [JP-A No. 6-209(1994)].

The massage movements are generally divided into those for the purpose of increasing the degree of relaxation and the intended to enhance the degree of refreshment. For example, for an increase in the degree of relaxation, it is effective to prolong the massage time for the part which feels comfortable when massaged to lower the activity of the autonomic nervous system of the person to be massaged, while for an increase in the degree of refreshment, it is effective to prolong the massage time for the part which feels comfortable when massaged to increase the activity of the autonomous nervous system of the person to be massaged. Accordingly, the massage movement needs to be changed over from one type to the other type in accordance with the contemplated purpose.

However, the massage machine is not designed to select the massage movement for an increased degree of relaxation or that for an increased degree of refreshment as desired and therefore has the problem of failing to produce a satisfactory massage affect.

Further with the massage machine described, detection of the relaxation indicating factor and the control of the massage mechanism based on the detection are effected concurrently, so that the machine has the problem of failing to produce a massaging movement fully reflecting the degree of relaxation of the person to be massaged.

The relationship between information such as pulse, body temperature or galvanic skin response (GSR) and the senses, preferences or condition of the person to be massaged still remains to be fully substantiated, hence the problem that the machine fails to give an effective massage in conformity with varying psychological conditions of the person.

Additionally the conventional massage machine requires that the person to be massaged wear a plurality of sensors for measuring the pulse, body temperature skin electrical resistance, etc., consequently making the person feel psychologically burdened and entailing the problem of failing to afford reliable measurement data. Since the sensors have respective signal lines connected thereto and restraining the movement of the person to be massaged, there is another problem that the person cannot be massaged in a relaxed state.

### SUMMARY OF THE INVENTION

A first object of the present invention is to provide a massage machine which is capable of giving an effective massage in conformity with the purpose.

To accomplish the first object, the present invention provides a massage machine which comprises a living body information sensor for detecting the living body information of the autonomic nervous system of the person to be massaged, and a control circuit for controlling a massage operation based on the living body information detected by the sensor. The control circuit comprises psychological state estimating means for estimating the psychological state of the person based on variations in the living body information detected by the sensor, and massage movement adjusting means for adjusting a massage movement in accordance with the estimated psychological state.

The massage movement adjusting means comprises mode changeover means for switching between a relaxation mode and a refreshment mode, the massage movement is so adjusted as to lower the activity of the autonomic nervous system in the relaxation mode, and the massage movement is so adjusted as to increase the activity of the autonomic nervous system in the refreshment mode.

With the massage machine of the invention, a preliminary massage operation is performed first to estimate the psychological state of the person to be massaged, and a full massage operation is thereafter performed. For the full massage operation, the massage movement is adjusted according to the result of estimation of the psychological state. In performing the full massage operation, the mode can be switched by the person to be massaged between the relaxation mode and the refreshment mode. When the relaxation mode is selected, an adjustment is made for reducing the activity of the autonomic nervous system, for example, an adjustment is so made as to prolong the massage time for the part that feels comfortable, whereby an improved degree of relaxation is available. When the refreshment mode is selected, on the other hand, an adjustment is made to increase the activity of the autonomic nervous system, for example, an adjustment is so made as to prolong the massage time for the part where both comfort and pain are perceived as the unique sensations to be experienced when stiff parts are massaged. This produces a high degree of refreshment.

Stated more specifically, the living body sensor comprises one or a plurality of sensors selected from among a galvanic skin response (GSR) sensor, pulse sensor and skin temperature sensor. It is known that the living body information detected by these sensors varies with the degree of relaxation or the degree of tension of the person to be massaged, such that when the person is relaxed, the degree of activity is low, and that when the person is tense, the degree of activity high. The psychological states of the person to be massaged including preferences, feeling of stiffness and physical condition can therefore be estimated with high reliability based on variations in the living body information detected by the sensors.

When the living body information sensor comprises, for example, a pulse sensor, a reduced pulse rate can be interpreted as indicating a relaxed state, while an increased pulse rate can be considered to be indicative of a tense state.

When the living body information sensor comprises a skin temperature sensor, a rise in the skin temperature can be interpreted as indicating a relaxed state, and a drop in the skin temperature as indicating a tense state.

Further when the living body information sensor comprises a GSR sensor, an impaired GSR can be interpreted as indicating a relaxed state, whereas higher GSR can be interpreted as indicating a tense state.

Stated more specifically, the control circuit gives different kinds of massages to a plurality of parts of the person to be massaged in the preliminary massage operation to estimate the psychological state of the person for each kind of massage given to each part, and adjusts the massage movement for each kind of the massage to be given to each part, according to the result of estimation of the psychological state, whereby the person is massaged effectively at the respective parts in conformity with his or her preference and condition.

Further stated specifically, the massage operation is executed by a sequence of massage movements, and the massage movement adjusting means of the control circuit comprises time adjusting means for adjusting the time required for a predetermined number of massage movements so as to complete the sequence of massage movements within approximately the same period of time whether the relaxation mode or the refreshment mode is selected. For example, suppose the relaxation mode is selected, and the massage time of a certain massage movement is then extended, or suppose the refreshment mode is selected, and the massage time of a certain massage movement is then shortened. Even in such cases, the time required for a sequence of massage movement in the relaxation mode becomes approximately the same as is required for a sequence of massage movement in the refreshment mode. Thus, the same massage effect is available whether one mode or the other mode is selected.

Thus, the user of the massage machine of the invention can be massaged effectively in conformity with the contemplated purpose.

A second object of the present invention is to provide a massage machine which is adapted to give an effective massage in accordance with various psychological states of the person to be massaged.

To accomplish this object, the present invention provides a massage machine comprising a living body information sensor for detecting the living body information of the autonomic nervous system of the person to be massaged, and a control circuit for controlling massage based on the living body information detected by the sensor. The control circuit comprises psychological state estimating means for estimating the psychological state of the person based on variations in the living body information detected by the sensor by executing a preliminary massage, and massage operation adjusting means for adjusting a full massage operation in accordance with the estimated psychological state.

The massage machine of the invention described first executes the preliminary massage to estimate the psychological state of the person to be massaged, and thereafter performs the full massage operation wherein the massage movement is adjusted in accordance with the estimated psychological state. The machine is therefore adapted to perform a massage operation fully reflecting the psychological state of the user, thus achieving a high massage effect. The psychological state estimated by executing the preliminary massage is stored in storage means such as a memory, and the stored psychological state is read from the storage means in performing the full massage operation for the adjustment of massage movement.

The user of the massage machine of the invention can be effectively massaged in accordance with his or her psychological state.

A third object of the present invention is to provide an electronic device, such as a massage machine, which has a controller for controlling the operation of the device in accordance with the psychological state of the operator, the controller being capable of accurately measuring factors indicating the psychological state of the operator without making the operator feel burdened.

To accomplish the third object, the present invention provides ah electronic device having a controller for transmitting control signals to a body of the device to control the operation of the device body. The controller comprises a casing to be grasped by one hand or both hands, manual keys arranged on the casing, and one or a plurality of living body information sensors arranged on the casing and positioned to be brought into contact with the grasping hand. The controller is adapted to transmit living body information detected by the sensors to the device body as control signals. On the other hand, the device body comprises a control circuit for receiving the control signals from the controller to control the operation of the device, and the control circuit comprises psychological state estimating means for estimating the psychological state of the operator based on variations in the living body information received as the control signals, and control means for controlling the operation of the device in accordance with the estimated psychological state. The controller is provided separately from the device body and transmits the control signals to the device body through a wire or wirelessly. Alternatively, the controller is joined to the device body and transmits the control signals to the device body through a wire.

With the electronic device of the invention provided with the controller, the operator grasps the controller by one hand or both hands, whereby the grasping hand is brought into contact with the living body information sensor or sensors arranged on the casing to detect the living body information of the operator. The living body information detected is sent to the device body as control signals. The control circuit of the device body in turn estimates the psychological state of the operator based on variations in the living body information and controls the operation of the device in accordance with the estimated psychological state. Thus, the living body information of the operator can be detected merely by grasping the controller with one hand or both hands in manipulating the device in the usual manner. The operator is therefore free from metal burden or will not feel restrained, or the device will not make the operator feel ill at ease. Consequently, the living body sensor or sensors afford measurement data of high reliability.

The electronic device having the controller and embodying the invention makes it possible to control the operation of the device in accordance with the psychological state of the operator and also to accurately measure the factors indicating the psychological state of the operator.

### BRIEF DESCRIPTION OF THE DRAWINGS

FIG. 1 is a perspective view of a massage machine of the invention during use;

FIG. 2 is a rear view showing the construction of the massage mechanism;

FIG. 3 is a rear view showing the construction of a therapeutic member drive device;

FIG. 4 is a block diagram showing the construction of a control system of the massage machine;

FIG. 5 is a perspective view showing the appearance of a remote controller;

FIG. 6 is a view showing an exemplary representation on a display of the remote controller;

FIG. 7 is a flow chart showing a preliminary massage procedure;

FIG. 8 is a flow chart showing a full massage procedure;

FIG. 9 is a relationship chart for use in estimating psychological states from variations in living body information in a detection sequence;

FIGS. 10(a) and 10(b) are charts showing rules for altering the massage time and the massage speed in accordance with the mode and the psychological state in full massage operation;

FIG, 11 is a chart for illustrating the relationship between variations in living body information and psychological states;

FIG. 12 is a table showing the result of an experiment for substantiating the reasonability of the chart of FIG, 11;

FIG. 13 is a graph showing a distribution of psychological states with GSR variations and skin temperature variations plotted as coordinate axes;

FIG. 14 is a graph showing a distribution of psychological states with GSR variations and pulse rate variations plotted as coordinate axes;

FIG. 15 is a table showing a sequence of massage movements and time adjustment in a relaxation mode;

FIG. 16 is a plan view of a horizontal remote controller;

FIGS. 17(a) and 17(b) are a plan view and a sectional view of a finger knob attached to the remote controller;

FIGS. 18(a) and 19(b) are a plan view and a rear view of a remote controller of the game machine type; and

FIG. 19 is a perspective view showing the rear side of the remote controller.

### DETAILED DESCRIPTION OF EMBODIMENTS

Embodiments of the present invention will be described below in detail.

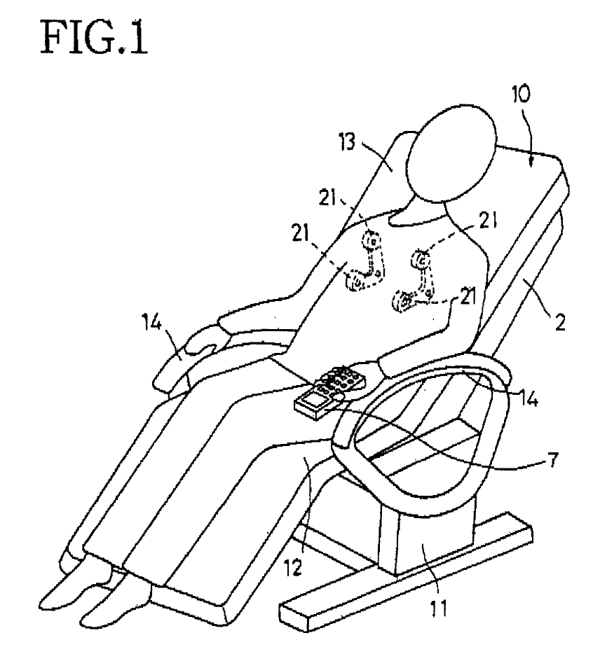

With reference to FIG. 1, the massage machine of the present invention comprises a chair body 10 including legs 11, seat 12, backrest 13 and a pair of opposite armrests 14, and a massage mechanism 2 having a plurality of therapeutic members 21 and incorporated into the chair body 10. The machine gives a massage to the human body by reciprocatingly moving the therapeutic members 21 up and down while vibrating these members 21.

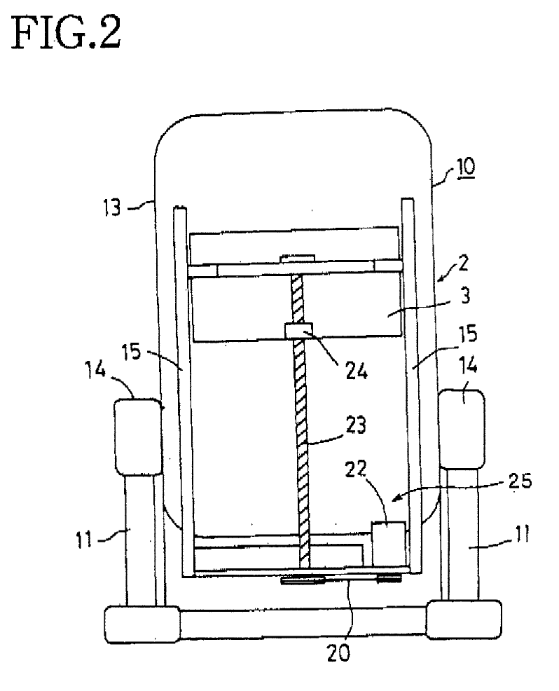

With reference to FIG. 2, the massage mechanism 2 has a therapeutic member drive device 3 provided on the back of the backrest 13 of the chair body 10 for vibrating the therapeutic members. The drive device 3 is supported by side frames 15, 15 attached to the back side of the backrest 13 and is movable upward and downward. The chair body 10 is provided with an up-down motor 22 for moving the therapeutic members 21 upward and downward. The up-down motor 22 is coupled to a screw rod 23 by a belt power transmission mechanism 20. The screw rod 23 is in screw-thread engagement with a bearing 24 attached to the drive device 3. Accordingly, when the screw rod 23 is rotatingly driven by the up-down motor 22, the drive device 3 is moved upward and downward with this movement.

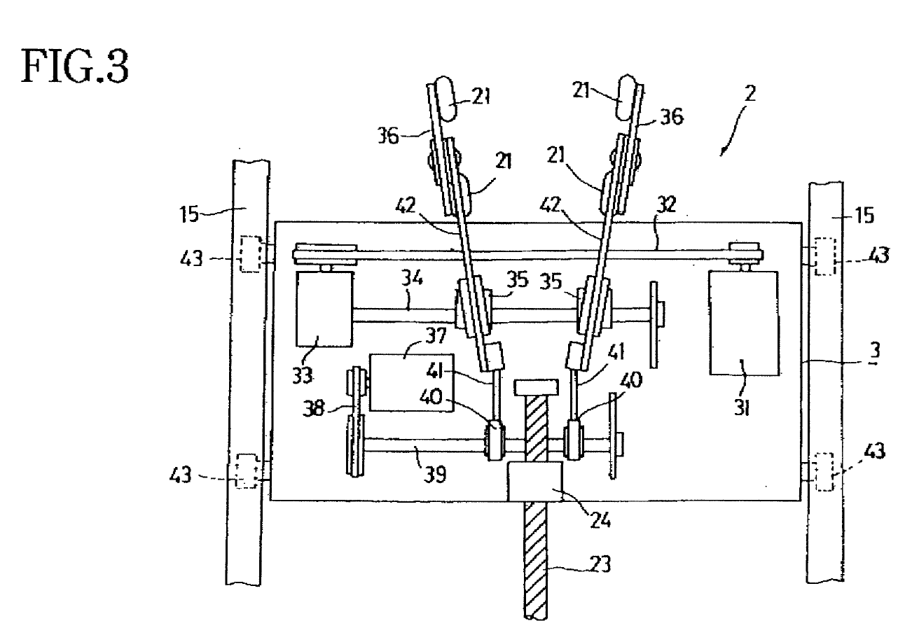

With reference to FIG. 3, the therapeutic member drive device 3 has a plurality of rollers 43, 43 at opposite sides. These rollers 43 are in engagement with the side frames 15, 15 for guiding the drive device 3 for upward and downward. The drive device 3 is provided with a kneading motor 31, which is coupled to a shaft 34 by way of a belt power transmission mechanism 32 and a speed change mechanism 33. The shaft 34 has mounted thereon a pair of opposite eccentric bearings 35, 35 for supporting a pair of opposite support arms 42. Pivoted to the outer end of each support arm 42 is a generally L-shaped pivotal arm 36. Therapeutic members 21, 21 are rotatably mounted on opposite ends of the pivotal arm 36, the shaft 34, when drivingly rotated by the kneading motor 31, pivotally drives the support arms 42, 42 toward or away from each other to thereby realizes a kneading movement by the therapeutic members 21.

The drive device 3 has a tapping motor 37, which is coupled to a shaft 39 by a belt power transmission mechanism 38. A pair of opposite eccentric bearings 40, 40 are mounted on the shaft 39 for supporting a pair of opposite rods 41, 41. The outer ends of the rods 41 are connected to the base ends of the respective arms 42. Accordingly, when rotatingly driven by the tapping motor 37, the shaft 39 pivotally drives the rods 41, 41 forward or rearward to thereby realize a tapping movement by the therapeutic members 21, 21.

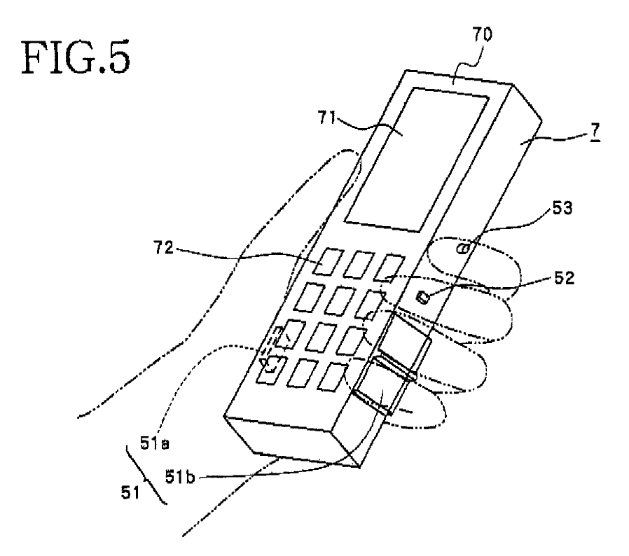

The massage machine of the present invention can be operated by manipulating a remote controller 7 as shown in FIG. 1. With reference to FIG. 5, the remote controller 7 comprises a display 71 and a plurality of manual buttons 72 arranged on the front side of a vertical casing 70. Arranged on the right side face of the casing 70 are a pulse sensor 52 comprising a light-emitting element and light-receiving element, and a skin temperature sensor 53 comprising a thermistor. A GSR sensor 51 comprising a pair of electrodes 51a, 51b is disposed on opposite side faces of the casing 70. When the controller 7 is grasped with the left hand as indicated in chain lines, the forefinger comes into contact with the skin temperature sensor 53, the middle finger with the pulse sensor 52, the ring finger and the little finger with the electrode 51b of the GSR sensor 51 and the palm with the other electrode 51a of the GSR sensor 51.

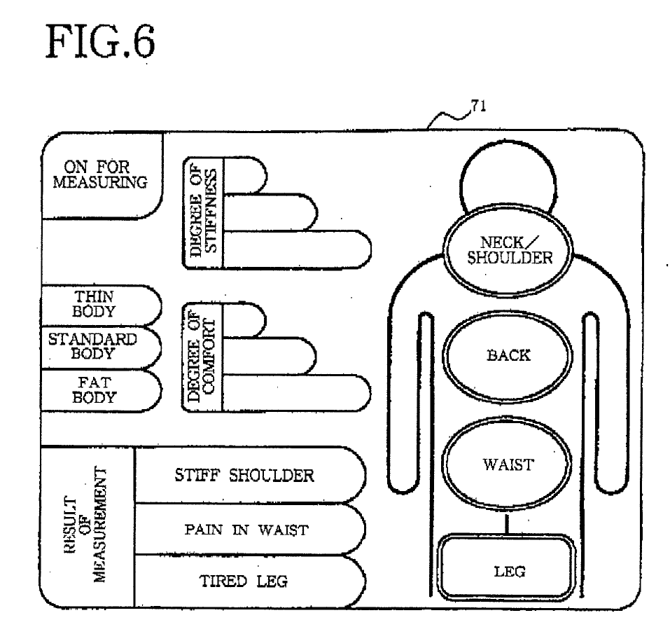

The other electrode 51a of the GSR sensor 51 is slidable upward or downward, such that the controller can be in intimate contact with the palm with good stability at all times regardless of the size of the hand which differs from person to person. Since variations in the area of contact of the electrodes of the GSR sensor 51 with the skin produce noise, at least one electrode 51a is made slidable to effectively suppress the noise due to variations in the contact area. The pulse sensor 52 and the skin temperature sensor 53 can also be made movable. To ensure a rapid response to mental loads, it is useful to make such a contrivance as to reduce the thermal capacity of the skin temperature sensor 53 as by providing a hollow portion below the portion where it is mounted. As seen in FIG. 6, the part being massaged degree of stiffness, degree of comfort, position of the stiff part, etc. are to be shown in the display 71 of the remote controller 7.

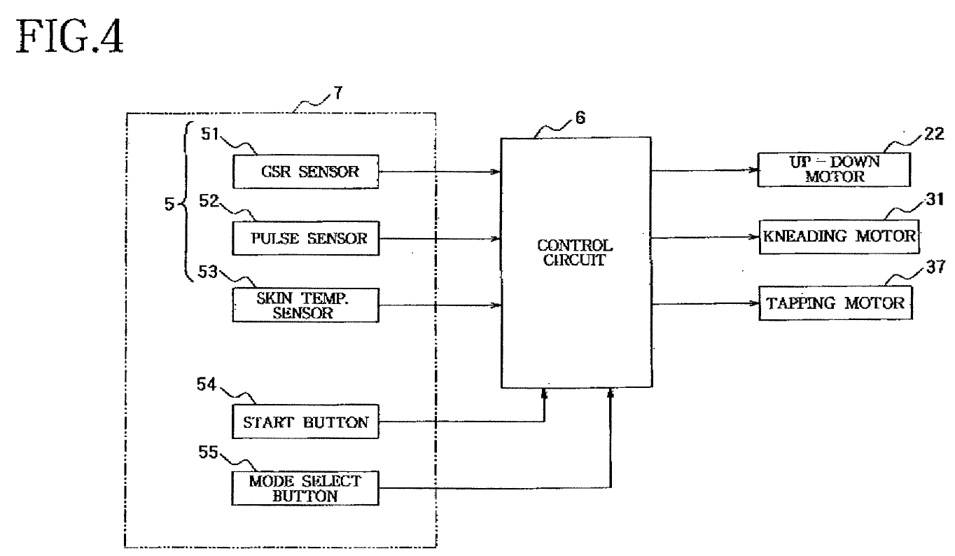

FIG. 4 shows the construction of a control system for the massage machine. A living body information sensor 5 comprising the GSR sensor 51, pulse sensor 52 and skin temperature sensor 53 is connected to input ports of a control circuit 6 comprising a microcomputer. Also connected to other input ports of the control circuit 6 are a start button 54 to be depressed for starting a massage operation, and a mode select button 55 to be depressed for switching between a relaxation mode and a refreshment mode. Connected to output ports of the control circuit 6 are the aforementioned up-down motor 22 kneading motor 31 and tapping motor 37.

When the start button 54 is depressed, the control circuit 6 is operated in the mode selected by the made select button 55, to execute first the preliminary massage procedure to be described below based on the signal from the living body information sensor 5 and thereafter perform the full massage procedure to be described later.

FIG. 11 shows the relationship between the living body information detected by the living body information sensor 5, i.e., GSR, skin temperature and pulse rate and the psychological state of the person to be massaged (user). As illustrated, the GSR, skin temperature and pulse rate vary in different modes with the degree of activity of the autonomic nervous system. When the degree of activity is low, GSR and pulse rate lower and the skin temperature rises. When the degree of activity is slightly low, GSR remains unchanged, but the skin temperature rises and the pulse rate drops. If the degree of activity is slightly high, GSR, rises from the constant level, the skin temperature lowers and the pulse rate rises. Further when the degree of activity is high, GSR greatly rises, the skin temperature drops and the pulse rate increases.

As the psychological states of the user in the event of such variations in the living body information, it is speculated that the user is in a relaxed comfortable state when the degree of activity is low, or that the user feels such a unique sensation as is experienced when massaged at a stiff part, feeling both pain and comfort as mingled therewith, when the degree of activity is slightly high, or that the user feels a pain when the degree of activity is high. When the degree of activity is neutral, the user will presumably be in a neutral state, feeling neither comfort nor pain.

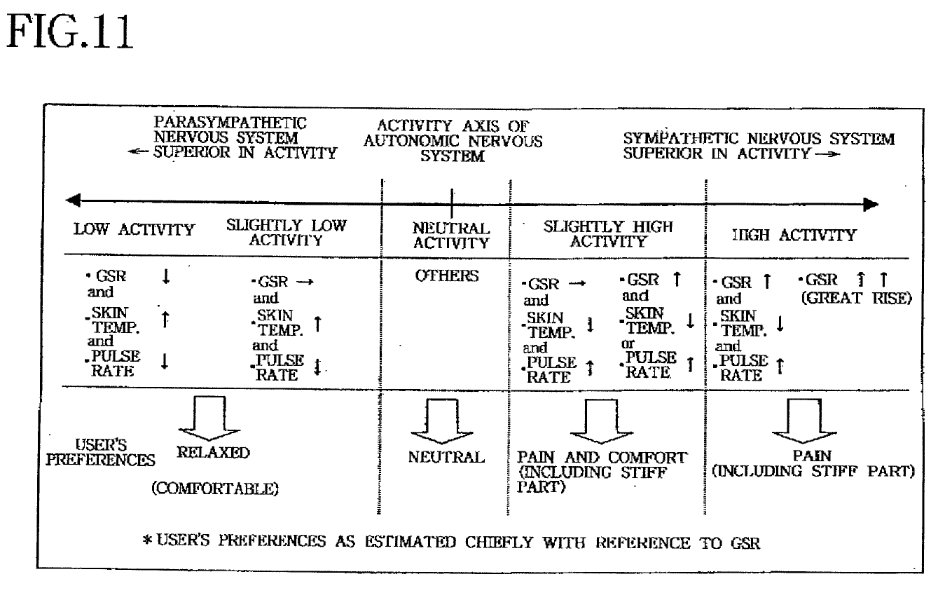

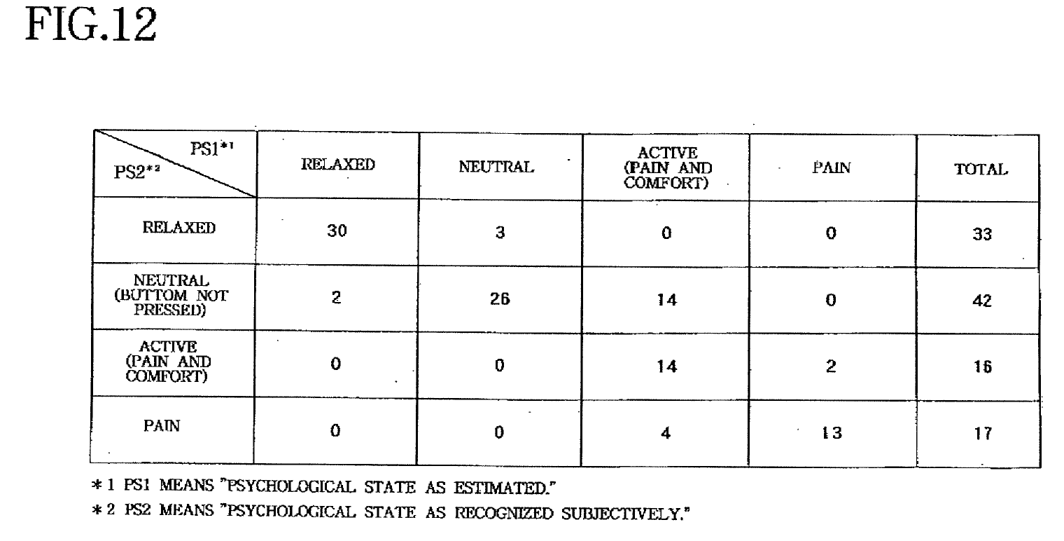

FIG. 12 shows the result of an experiment conducted to substantiate the above relationship between the living body information and the psychological state. For the experiment, twelve persons were given nine kinds of massages and asked for the psychological state (relaxed, neutral, both pain and comfort, pain) as recognized subjectively by themselves, while the examiners were checked for living body information (GSR, skin temperature, pulse rate) to estimate their psychological state based on the relationship of FIG, 11. The data obtained (108 items) was listed into a table as shown in FIG. 12. The listed result indicates a high correlation between the psychological state as recognized by the examinees and the estimated state, indicating that the estimation of the psychological state based on the relationship of FIG. 11 is reasonable.

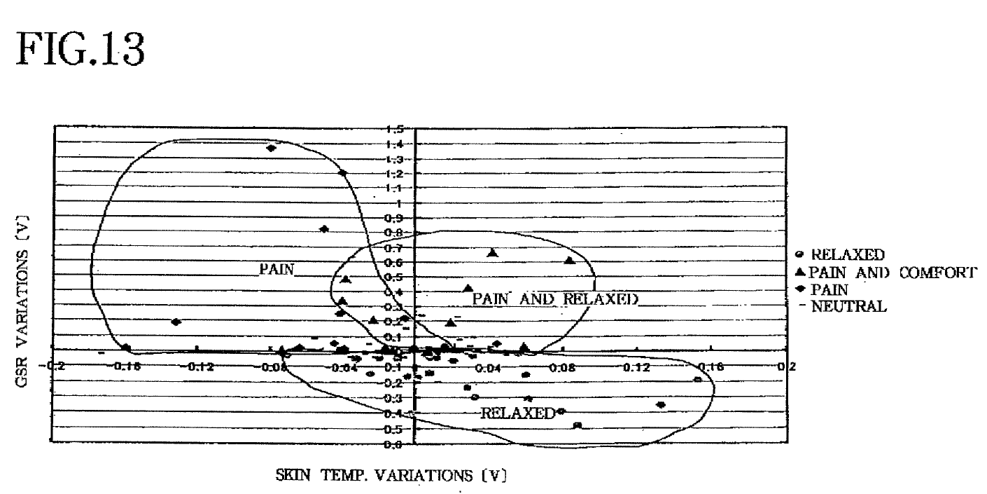

FIG. 13 shows a distribution of psychological states (relaxed, neutral, both pain and comfort, pain) with GSR variations and skin temperature variations plotted as Y-axis and X-axis coordinates. This result reveals that variations in GSR and variations in skin temperature indicate the three psychological states of feeling relaxed, both pain and comfort, and pain generally accurately, as distinguished from one another.

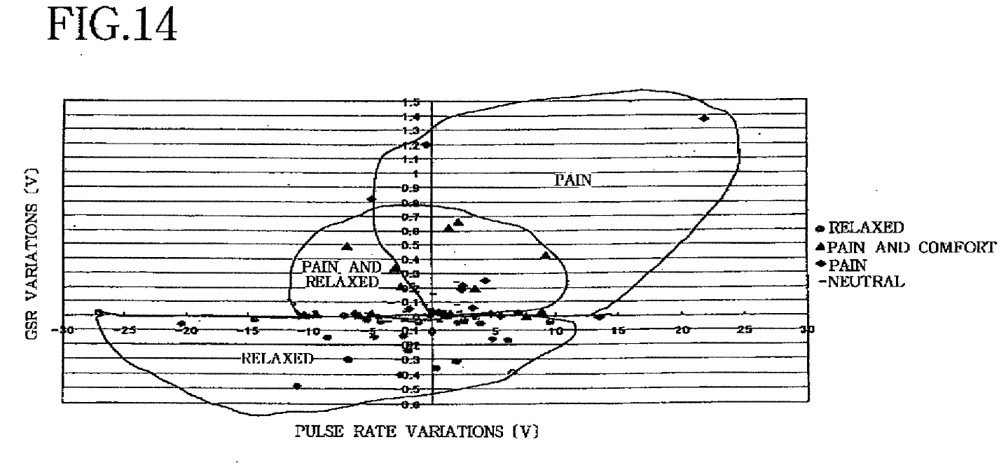

FIG. 14 shows a distribution of psychological states (relaxed, neutral, both pain and comfort, pain) obtained b y plotting GSR variations and pulse rate variations as Y-axis and X-axis coordinates. This result reveals that variations in GSR and variations in pulse rate make it possible to distinguish among the three psychological states of feeling relaxed, both pain and comfort, and pain generally accurately, especially to distinguish between relaxation and pain.

Thus, the psychological state of the user can be estimated from the relationship of FIG. 11 by detecting variations in GSR, skin temperature and pulse rate while giving various massages to parts of the user. According to the present invention, such variations are detected by the preliminary massage operation to be described below. The user can be massaged according to his or her preference by recognizing the user' preference in the kind of massage for various parts from the psychological state of the user. According to the invention, this mode of massage is performed by the full massage operation to be described below.

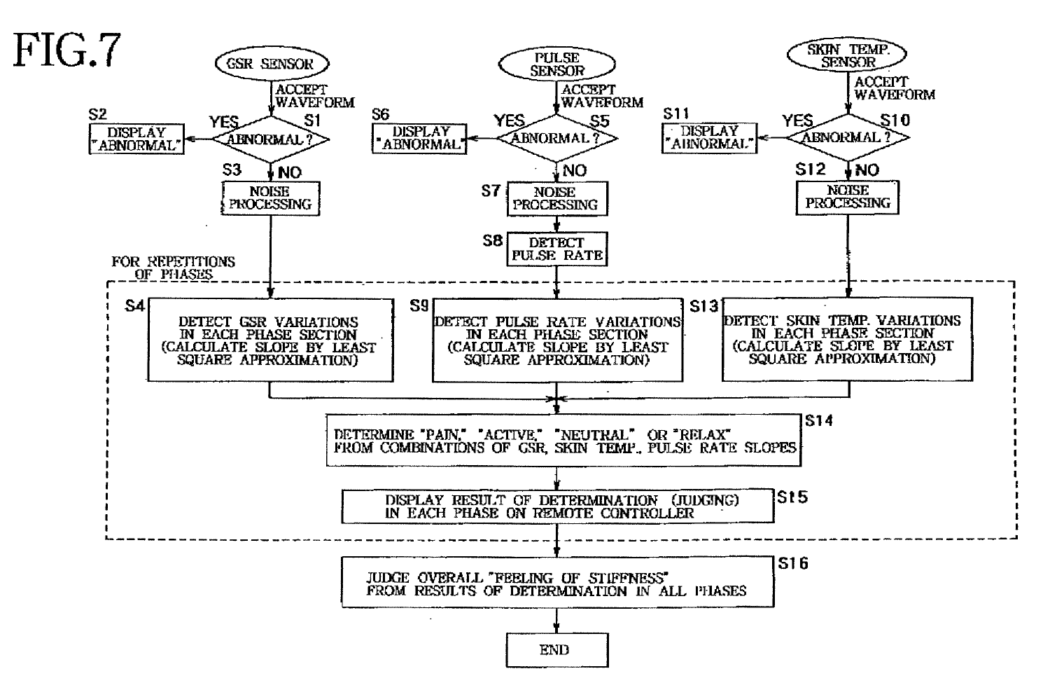

The preliminary massage operation is performed by the procedure shown in FIG. 7. Waveform is received from the GSR sensor to inquire whether the waveform, for example, resulting from release of the hand from the sensor is found abnormal in step S1. If the answer is affirmative, “abnormal” is displayed in step S2. When the waveform is found normal, step S3 follows for noise removal processing. The sequence then proceeds to step S4 to detect variations of GSR in each phase section (each massage movement). Slope can be detected, for example, by calculating the slope of GSR variations by least square approximation.

Further in step S5, waveform is received from the skin temperature sensor and checked for abnormality. If it is found abnormal, “abnormal” is displayed in step S6. When the waveform is found normal, step S7 follows for noise removal processing. The pulse rate is then detected in step S8. The sequence then proceeds to step S9 to detect variations of pulse rate in each phase section. Slope can be detected, for example, by calculating the slope of pulse rate variations by least square approximation.

Further in step S10, waveform is received from the skin temperature sensor and checked for abnormality. If it is found abnormal, “abnormal” is displayed in step S11. When the waveform is found normal, step S12 follows for noise removal processing. The sequence then proceeds to step S13 to detect variations of the skin temperature in each phase section. Slope can be detected, for example, by calculating the slope of skin temperature variations by least square approximation.

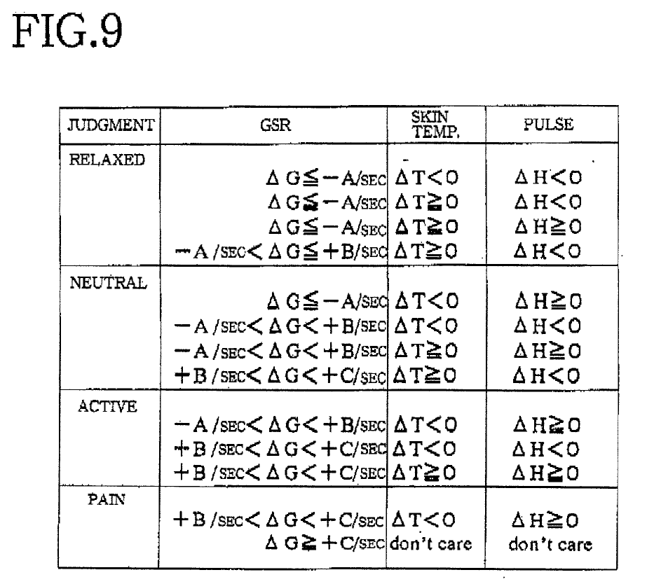

After the execution of steps S4, S9 and S13, step S14 follows to determine “pain,” “active,” “neutral” or “relaxed” from combinations of GSR variations ΔG, skin temperature variations ΔT and pulse rate variations ΔH shown in FIG. 9. Incidentally, FIG. 9 shows the estimation of psychological states based on the relationship of FIG. 11 as formulated.

Subsequently step S15 of FIG. 7 displays on the remote controller the result of judgment of the psychological state in each phase (each massage movement). After repeating steps S4, S9, S13, S14 and S15 a number of times for the repetitions of all the phases, the sequence proceeds to step S16, in which an overall “feeling of stiffness” is judged from the results of judgment in all phases, and the result is displayed on the remote controller to complete the procedure. The result of judgment in each phase is stored in a memory incorporated in the control circuit.

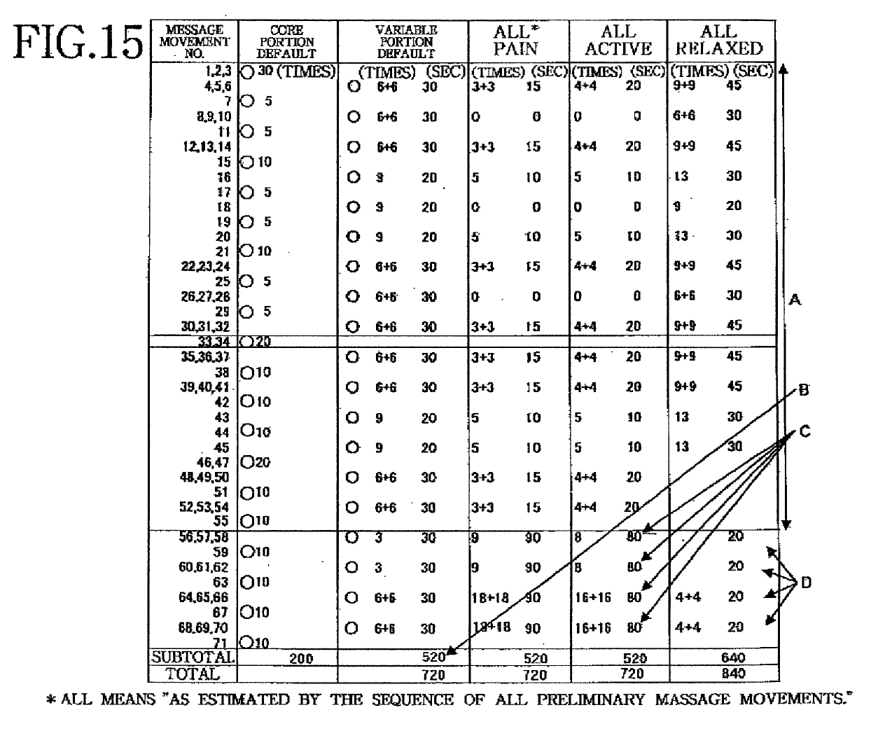

For the full massage operation, various massage movements (tapping, kneading, rolling, etc.) are performed on various parts (shoulders, back, waist, legs). The full massage operation in the relaxation mode comprises, for example, massage movements No. 1 to No. 71 shown in FIG. 15. Each massage movement is classified as a core portion of fixed duration or as a variable portion with variable duration and frequency. The time (duration) and frequency of each massage movement as a variable portion are adjusted according to the selected mode (relaxation mode or refreshment mode). Incidentally, the movements No. 1 to No. 71 of the full massage operation include massage movements of the preliminary massage operation as distributed in the former operation.

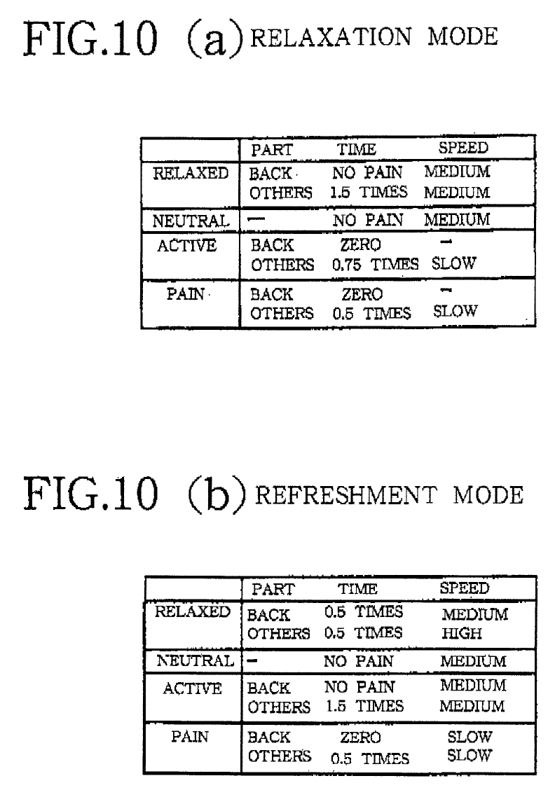

FIGS. 10(a) and 10(b) show rules for adjusting the massage time and the massage speed in accordance with the psychological state in the relaxation mode and the refreshment mode, respectively. For example when the psychological state is estimated to be “relaxed” in the case where the relaxation mode is selected, the massage time for the parts other than the back is extended, with the massage speed held at medium level. The particulars for others are as listed in FIG. 10(a). In this way, an improved degree of relaxation will be achieved.

When the psychological state is estimated to be “active (both pain and comfort)” in the case where the refreshment mode is selected, the massage time for the parts other than the back is extended, with the massage speed held at medium level. The particulars for others are as listed in FIG. 10(b). In this way, an improved degree of refreshment will be achieved.

Time adjustment is made so that the duration of the sequence of massage movements will not be changed greatly by altering the massage time and massage speed. For example in the case of the relaxation mode shown in FIG. 15, altered first are the massage time and the massage speed of the variable portions included in the massage movements No. 1 to No. 55 indicated by arrows A. The time required for the movements No. 1 to No. 55 after the variable portion alterations is calculated, and the required time is subtracted from the variable portion default time (520 sec) to calculate the time difference indicated by arrow B.

In the case where the time difference is not smaller than 120 sec, this time difference is divided by 4 to calculate the lengths of time for the four variable portions involved in the massage movements No. 56 to No. 71. However, the quotient resulting from the division by 4 is taken as an upper limit to avoid excessive time after the alteration. Alternatively if the time difference is at least 60 sec to less than 120 sec, the massage movements No. 56 to No. 71 are effected with the default value. If the time difference is less than 60 sec, the massage movements No. 56 to No. 71 are each performed for 20 sec. Time adjustment can be made similarly also in the refreshment mode.

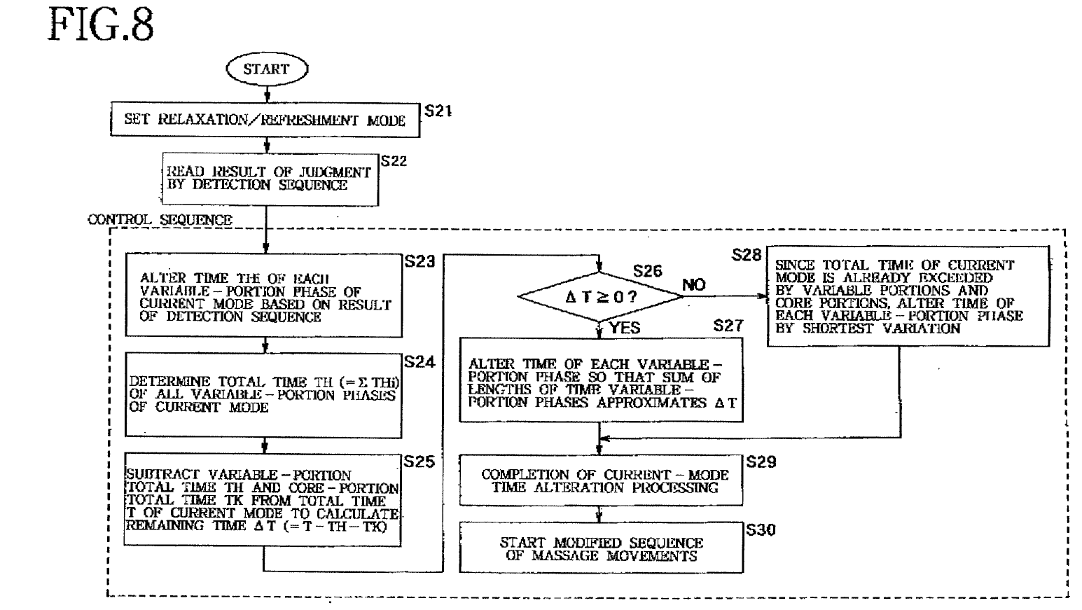

For the full massage operation, the procedure shown in FIG. 8 is executed. In response to a select signal from the mode select button 55, the relaxation mode or refreshment mode is set first in step S21, and the result of judgment by the detection sequence is read from the memory in step S22.

Based on the result of psychological state estimation by the detection sequence, the time THi of each variable-portion phase of the relaxation/refreshment mode (current mode) is then altered in step S23. In step S24, total time TH (=ΣTHi) of all phases of variable portions providing the current mode is determined. Subsequently, the total time TH of the variable portions and the total time TK of the core portions are subtracted from the total time T of the current mode to calculate remaining time ΔT in step S25.

An inquiry is thereafter made in step S26 as to whether the remaining time ΔT is not smaller than 0. When the answer is affirmative, step S27 follows to alter the time of each variable-portion phase so that the sum of lengths of time of the variable-portion phases approximates ΔT. If the answer to the inquiry of step S26 is negative, the sequence proceeds to step S28. Since the total time of the current mode is already exceeded by the variable portions and the core portions, the time of each variable-portion phase is altered by a variation of shortest value in this step. The processing for altering the time of the current mode is completed in step S29, followed by step S30 to start a modified sequence of massage movements in the current mode.

Thus, in the relaxation mode or refreshment mode, the user can be massaged for a suitable period of time in conformity with his or her preference.

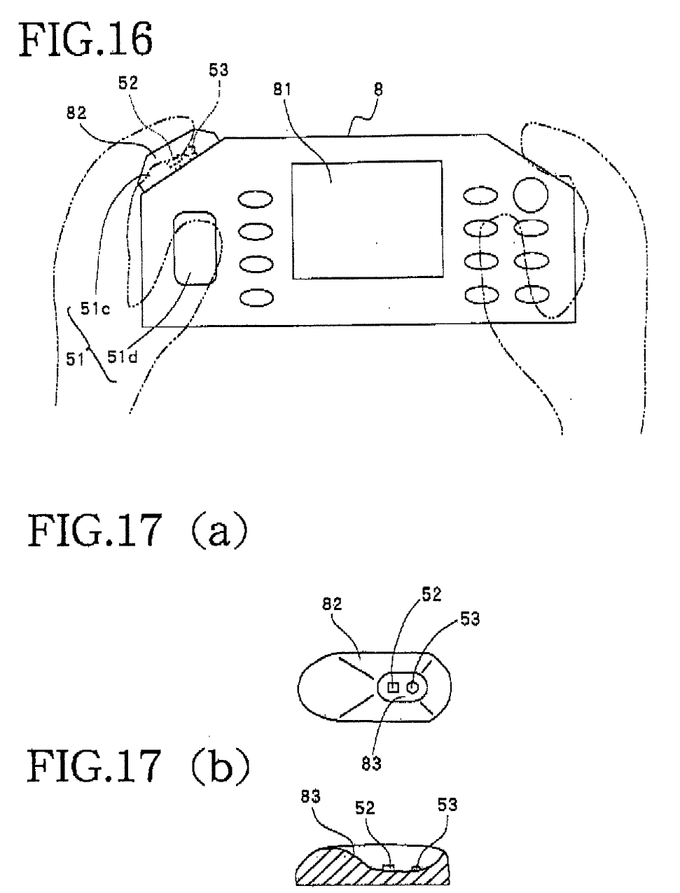

In the case of the foregoing embodiment, the remote controller 7 of the vertical type which can be grasped by one hand has the GSR sensor 51, pulse sensor 52 and skin temperature sensor 53 in the arrangement shown in FIG. 5. FIG. 16 shows a remote controller 8 which is to be grasped with both hands. The sensors can be provided on the controller 8 in the illustrated arrangement. The remote controller 8 has a display 81, and a finger knob 82 of resin (e.g. ABS resin) attached to one end of its casing for placing the forefinger of the left hand thereon. The finger knob 82 has a caved face 83 for the fingertip to fit in. A pulse sensor 52 and a skin temperature sensor 53 are arranged at the bottom of the caved face 83 as seen in FIGS. 17(a) and 17(b). As shown in FIG. 16, a GSR sensor 51 comprises a pair of electrodes 51c, 51d. One of the electrodes, 51c, is provided by plating the surface of the finger knob 82 with a conductive metal such as nickel, while the other electrode 51d comprises a metal plate attached to the surface of the casing in corresponding relation with the position of the thumb.

With the remote controller 8, the pulse sensor 52 and the skin temperature sensor 53 are arranged at the bottom of the caved face 83 of the finger knob 82 as seen in FIGS. 17(a) and 17(b), so that the tip of the forefinger can be brought into intimate contact with the two sensors smoothly, whereby stabilized measurement signals can be obtained free of noise.

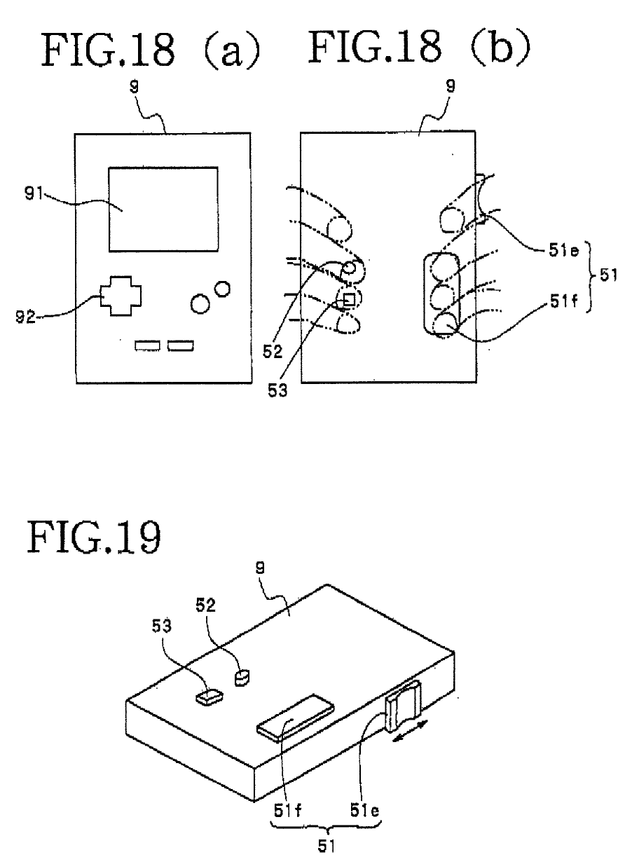

FIG. 18(a) shows a remote controller 9 of the game machine type having a display 91 and a manual key 92. As shown in FIG. 18(b), the casing of the controller has a pulse sensor 52 and skin temperature sensor 53 which are arranged on the rear side thereof in corresponding relation with the middle finger and ring finger of the right hand, and one electrode 51e providing a GSR sensor 51 and disposed on a side face of the casing in corresponding relation with the bulging portion of forefinger of the left hand. The other electrode 51f can be disposed on the casing rear side in corresponding relation with the middle finger, ring finger and little finger of the left hand (see FIG. 19).

As indicated by a double arrow in FIG. 19, the electrode 15e of the GSR sensor 51 is provided with a caved-in face to which the bulging portion of the forefinger is fittable, and is attached to the casing side face so as be slidable reciprocatingly along this face. This assures reliable contact at all times regardless of the length of the forefinger which differs from person to person. Further the pulse sensor 52 and the skin temperature sensor 53 can be provided with a guide member surrounding the sensor so as to render the finger positionable in place with good stability, whereby noise-free measurement signals are made available.

What is claimed is:

1. A massage machine comprising a living body information sensor for detecting the living body information of the autonomic nervous system of the person to be massaged, and a control circuit for controlling a massage operation based on the living body information detected by the sensor, the control circuit comprising psychological state estimating means for estimating the psychological state of the person based on variations in the living body information detected by the sensor, and massage movement adjusting means for adjusting a massage movement in accordance with the estimated psychological state.

2. A massage machine according to claim 1 wherein the massage movement adjusting means comprises mode changeover means for switching between a relaxation mode and a refreshment mode, and the massage movement is so adjusted as to lower the activity of the autonomic nervous system in the relaxation mode and is so adjusted as to increase the activity of the autonomic nervous system in the refreshment mode.

3. A massage machine according to claim 1 wherein the living body information sensor includes one or a plurality of sensors selected from among a galvanic skin response sensor, a pulse sensor and a skin temperature sensor.

4. A massage machine according to claim 3 wherein when the living body information sensor comprises a galvanic skin response sensor, the psychological state estimating means of the control circuit interprets an impaired galvanic skin response as indicating a relaxed state, and a higher galvanic skin response as indicating a tense state.

5. A massage machine according to claim 3 wherein when the living body information sensor comprises a pulse sensor, the psychological state estimating means of the control circuit interprets a reduced pulse rate as indicating a relaxed state, and an increased pulse rate as indicating a tense state.

6. A massage machine according to claim 3 wherein when the living body information sensor comprises a skin temperature sensor, the psychological state estimating means of the control circuit interprets a rise in the skin temperature as indicating a relaxed state, and a drop in the skin temperature as indicating a tense state.

7. A massage machine according to claim 3 wherein the psychological state estimating means of the control circuit judges the level of activity of the person in accordance with variations in at least one item of living body information selected front among galvanic skin response, pulse rate and skin temperature, and interprets low activity as indicating a relaxed state and high activity as indicating a tense state.

8. A massage machine according to claim 1 wherein the control circuit gives different kinds of massages to a plurality of parts of the person in estimating the psychological state to estimate the psychological state for each kind of massage given to each part, and adjusts the massage movement for each kind of the massage to be given to each part in accordance with the result of estimation of the psychological state.

9. A massage machine according to claim 2 wherein the massage operation is executed by a sequence of massage movements, and the massage movement adjusting means of the control circuit comprises time adjusting means for adjusting the time required for a predetermined number of massage movements so as to complete the sequence of massage movements within approximately the same period of time whether the relaxation mode or the refreshment mode is selected.

10. A massage machine comprising a living body information sensor for detecting the living body information of the autonomic nervous system of the person to be massaged, and a control circuit for controlling massage based on the living body information detected by the sensor, the control circuit comprising psychological state estimating means for estimating the psychological state of the person based on variations in the living body information detected by the sensor by executing a preliminary massage, and massage operation adjusting means for adjusting a full massage operation in accordance with the estimated psychological state.

11. A massage machine according to claim 10 which further comprises memory means for storing the result of estimation of the psychological state, and the massage operation is adjusted based on the result of estimation of the psychological state read from the storage means.

12. A massage machine according to claim 10 wherein the living body information sensor includes one or a plurality of sensors selected from among a galvanic skin response sensor, a pulse sensor and a skin temperature sensor.

13. A massage machine according to claim 12 wherein when the living body information sensor comprises a galvanic skin response sensor, the psychological state estimating means of the control circuit interprets an impaired galvanic skin response as indicating a relaxed state, and a higher galvanic skin response as indicating a tense state.

14. A massage machine according to claim 12 wherein when the living body information sensor comprises a pulse sensor, the psychological state estimating means of the control circuit interprets a reduced pulse rate as indicating a relaxed state, and an increased pulse rate as indicating a tense state.

15. A massage machine according to claim 12 wherein when the living body information sensor comprises a skin temperature sensor, the psychological state estimating means of the control circuit interprets a rise in the skin temperature as indicating a relaxed state, and a drop in the skin temperature as indicating a tense state.

16. A massage machine according to claim 12 wherein the psychological state estimating means of the control circuit judges the level of activity of the person in accordance with variations in at least one item of living body information selected from among galvanic skin response, pulse rate and skin temperature, and interprets low activity as indicating a relaxed state and high activity as indicating a tense state.

17. A massage machine according to claim to wherein the massage operation adjusting means comprises mode changeover means for switching between a relaxation mode and a refreshment mode, and adjusts different massage movements in the different modes.

18. A massage machine according to claim 10 wherein the control circuit gives different kinds of massages to a plurality of parts of the person in the preliminary massage to estimate the psychological state for each kind of massage given to each part, and adjusts the massage movement for each kind of the massage to be given to each part in the full massage operation, in accordance with the result of estimation of the psychological state.

19. An electronic device having a controller for transmitting control signals to a body of the device to control the operation of the device body, the controller comprising a casing to be grasped by one hand or both hands, manual keys arranged on the casing, and one or a plurality of living body information sensors arranged on the casing and positioned to be brought into contact with the grasping hand, the controller being operable to transmit living body information detected by the sensors to the device body as control signals, the device body comprising a control circuit for receiving the control signals from the controller to control the operation of the device, the control circuit comprising psychological state estimating means for estimating the psychological state of the operator based on variations in the living body information received as the control signals, and control means for controlling the operation of the device in accordance with the estimated psychological state.

20. An electronic device according to claim 19 wherein the controller is provided separately from the device body and transmits the control signals to the device body through a wire or wirelessly.

21. An electronic device according to claim 19 wherein the controller is joined to the device body and transmits the control signals to the device body through a wire.

22. An electronic device according to claim 19 wherein the living body information sensor includes one or a plurality of sensors selected from among a galvanic skin response sensor, a pulse sensor and a skin temperature sensor.

23. An electronic device according to claim 22 wherein when the living body information sensor comprises a galvanic skin response sensor, the psychological state estimating means of the control circuit interprets an impaired galvanic skin response as indicating a relaxed state, and a higher galvanic skin response as indicating a tense state.

24. An electronic device according to claim 22 wherein when the living body information sensor comprises a pulse senor the psychological state estimating means of the control circuit interprets a reduced pulse rate as indicating a relaxed state, and an increased pulse rate as indicating a tense state.

25. An electronic device according to claim 22 wherein when the living body information sensor comprises a skin temperature sensor, the psychological state estimating means of the control circuit interprets a rise in the skin temperature as indicating a relaxed state, and a drop in the skin temperature as indicating a tense state.

26. An electronic device according to claim 22 wherein the psychological state estimating means of the control circuit judges the level of activity of the operator in accordance with variations in at least one item of living body information selected from among galvanic skin response, pulse rate and skin temperature, and interprets low activity as indicating a relaxed state and high activity as indicating a tense state.
